(19) United States
(12) Patent Application Publication
(10) Pub. No.: US 2026/0036473 A1
(43) Pub. Date: Feb. 5, 2026

(54) STRESS SENSING ELEMENT HAVING DIAPHRAGM WITH VERTICAL PROTRUSIONS

(71) Applicant: Asia Pacific Microsystems, Inc., Hsinchu (TW)

(72) Inventors: Jerwei Hsieh, Hsinchu (TW); Hung-Lin Yin, Hsinchu (TW); Jr-Wei Chang, Hsinchu (TW)

(73) Assignee: Asia Pacific Microsystems, Inc., Hsinchu (TW)

(21) Appl. No.: 19/183,790

(22) Filed: Apr. 19, 2025

(30) Foreign Application Priority Data
Aug. 5, 2024 (CN) 202411063764.5
Aug. 5, 2024 (TW) 113129148

(51) Int. Cl. G01L 1/18

(52) U.S. Cl. CPC G01L 1/18

(57) ABSTRACT

A stress sensing element comprises a substrate, a structured silicon layer, a substrate connection layer attached to the substrate and the structured silicon layer, and a top silicon layer. The substrate comprises one or more through holes. The structured silicon layer comprises one or more protrusion elements, an outer frame, and a cavity connected to the one or more through holes of the substrate. The top silicon layer comprises a supported region, a suspended region, and one or more stress sensing units. The supported region of the top silicon layer is supported by the outer frame of the structured silicon layer. The suspended region comprises a diaphragm. The one or more stress sensing units sense stresses in the suspended region. The one or more protrusion elements of the structured silicon layer are attached to the diaphragm of the suspended region of the top silicon layer.

### CROSS-REFERENCE TO RELATED APPLICATIONS

This patent application claims priority of Taiwan Patent Application No. 113129148 filed on Aug. 5, 2024 and China Patent Application No. 202411063764.5 filed on Aug. 5, 2024. The entire disclosure made in the Taiwan Patent Application No. 113129148 and the entire disclosure made in the China Patent Application No. 202411063764.5 are hereby incorporated by reference.

### FIELD OF THE INVENTION

This invention relates generally to a sensor having a diaphragm. More particularly, the present invention relates to a stress sensing element having a diaphragm with vertical protrusions.

### BACKGROUND OF THE INVENTION

A stress sensing element may be used in a variety of applications, such as pressure sensors and vibration sensors. A resistance of a piezo-resistive sensor of the stress sensing element on a cantilever beam changes when stresses are developed in the cantilever beam and the cantilever beam deforms under pressure difference at two ends of the cantilever beam or deforms under assertion of an external force. A circuit outputs a signal representing the change of the resistance of the piezo-resistive sensor thereby a value of the pressure difference or a value of the external force may be calculated.

To sense a tiny change of pressure or an external force, the piezo-resistive sensor is required to be highly sensitive thereby comprising a long cantilever beam or a thin membrane. But, a long cantilever beam or a thin membrane will result in non-linearity between the resistance and stress due to large deformation, low yield, and cost increase. The present disclosure will provide a solution to this issue.

### SUMMARY OF THE INVENTION

A stress sensing element comprises a substrate, a structured silicon layer, and a top silicon layer. The substrate comprises one or more through holes. The structured silicon layer comprises one or more protrusion elements, an outer frame, and a cavity connected to the one or more through holes of the substrate. The top silicon layer comprises a supported region, a suspended region, and one or more stress sensing units. The supported region of the top silicon layer is supported by the outer frame of the structured silicon layer. The suspended region comprises a diaphragm. The one or more stress sensing units sense stresses in the suspended region. The one or more protrusion elements of the structured silicon layer are attached to the diaphragm of the suspended region of the top silicon layer.

### BRIEF DESCRIPTION OF THE DRAWINGS

FIG. 1 is a top view of a first stress sensing element in examples of the present disclosure.

FIG. 2 is a cross-sectional view, viewed along a direction perpendicular to II-II line, of the first stress sensing element of FIG. 1 in examples of the present disclosure.

FIG. 3 is a cross-sectional view of a second stress sensing element in examples of the present disclosure.

FIG. 4 is a cross-sectional view of a third stress sensing element in examples of the present disclosure.

FIG. 5 is a cross-sectional view of a fourth stress sensing element in examples of the present disclosure.

FIG. 6 is a cross-sectional view of a fifth stress sensing element in examples of the present disclosure.

FIG. 7 is a cross-sectional view of a sixth stress sensing element in examples of the present disclosure.

FIGS. 8A, 8B, 8C, and 8D show cross-sectional views of a first portion of a process to fabricate stress sensing elements of FIGS. 1-6 in examples of the present disclosure.

FIGS. 9A, 9B, and 9C show cross-sectional views of a second portion of a process to fabricate stress sensing elements of FIGS. 1-6 in examples of the present disclosure.

FIG. 10A shows a scanning electron microscope (SEM) plot of a stress sensing element and FIG. 10B shows a SEM plot of another stress sensing element in examples of the present disclosure.

FIG. 11 is a cross-sectional view of a seventh stress sensing element in examples of the present disclosure.

FIG. 12 is a cross-sectional view of an eighth stress sensing element in examples of the present disclosure.

FIG. 13 is a cross-sectional view of a ninth stress sensing element in examples of the present disclosure.

FIGS. 14A, 14B, 14C, and 14D show cross-sectional views of a portion of a process to fabricate stress sensing elements of FIGS. 12 and 13 in examples of the present disclosure.

FIG. 15 is a cross-sectional view of a tenth stress sensing element in examples of the present disclosure.

FIG. 16 is a cross-sectional view of a combo stress sensing element in examples of the present disclosure.

FIG. 17 is a cross-sectional view of an eleventh stress sensing element in examples of the present disclosure.

FIGS. 18A, 18B, and 18C show cross-sectional views of a first portion of a process to fabricate stress sensing elements of FIG. 17 in examples of the present disclosure.

FIGS. 19A, 19B, and 19C show cross-sectional views of a second portion of a process to fabricate stress sensing elements of FIG. 17 in examples of the present disclosure.

### DETAILED DESCRIPTION OF THE INVENTION

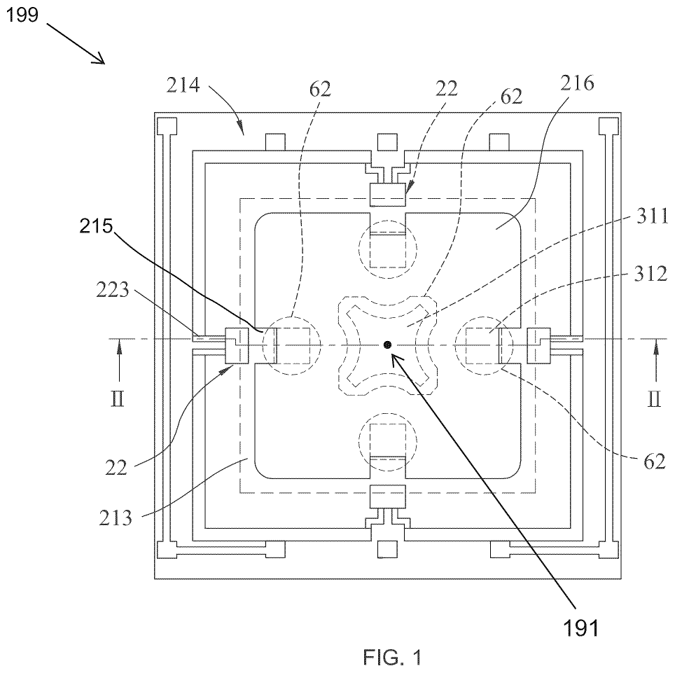

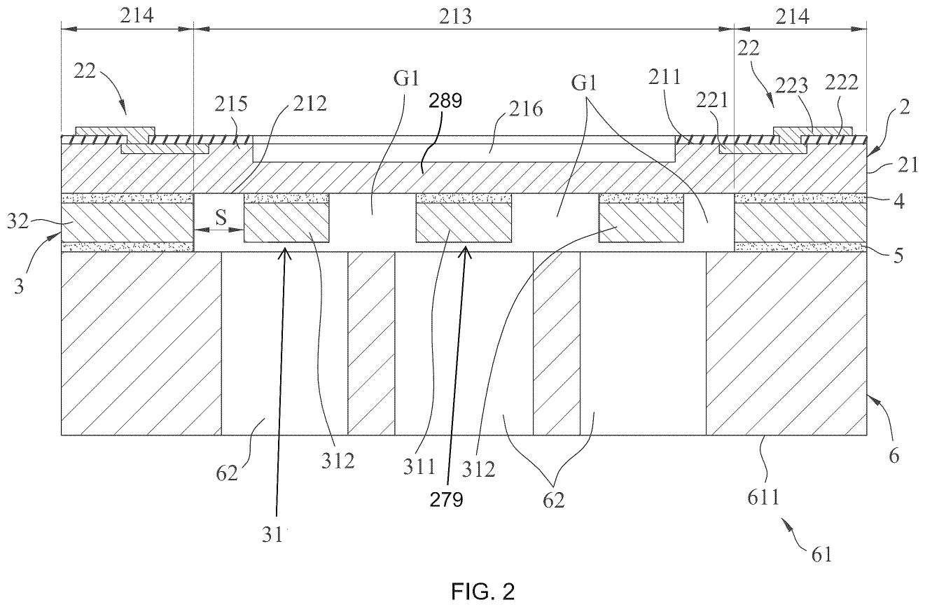

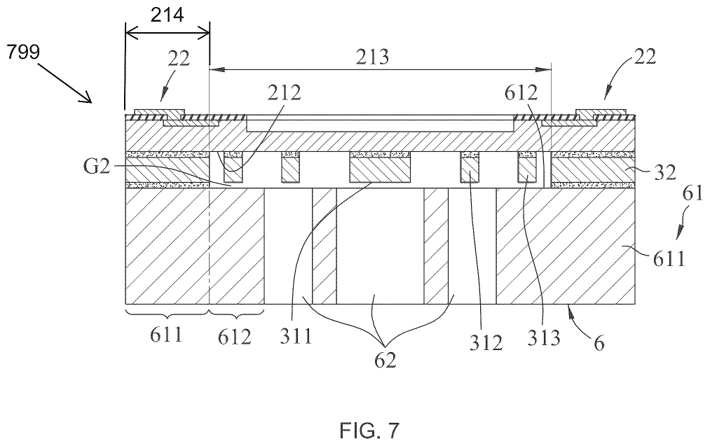

FIG. 1 is a top view of a stress sensing element 199 in examples of the present disclosure. FIG. 2 is a cross-sectional view, viewed along a direction perpendicular to II-II line, of the stress sensing element 199 of FIG. 1 in examples of the present disclosure. The stress sensing element 199 comprises a substrate 6, a substrate connection layer 5, a structured silicon layer 3, and a top silicon layer 2. The substrate 6 comprises one or more through holes 62. The substrate connection layer 5 is attached to the substrate 6. The structured silicon layer 3 comprises one or more protrusion elements 31, an outer frame 32, and a cavity G1. In one example, the one or more protrusion elements 31 comprise a protrusion element 311. In another example, the one or more protrusion elements 31 comprise a protrusion element 311 and at least four side-protrusion elements 312. In still another example, the one or more protrusion elements 31 comprise a protrusion element 311, at least four side-protrusion elements 312, and at least four constrained-protrusion elements 313 of FIG. 7. The outer frame 32 is attached to the substrate connection layer 5. The cavity G1 is connected to the one or more through holes 62 of the substrate 6.

The top silicon layer 2 comprises a supported region 214, a suspended region 213, and one or more stress sensing units 22. The supported region 214 is supported by the outer frame 32 of the structured silicon layer 3. The suspended region 213 comprises a diaphragm 289. The one or more stress sensing units 22 sense stresses in the suspended region 213 while under applied pressure. The protrusion element 311 of the one or more protrusion elements 31 of the structured silicon layer 3 is attached to the diaphragm 289 of the supported region 214 of the top silicon layer 2.

The advantage of the protrusion element 311 is to facilitate the flatness of the diaphragm 289 so as to reduce the non-linearity between resistance and stress. The protrusion element 311 also reduces deformation of the diaphragm 289 during high temperature manufacturing step thereby facilitating low zero offset (for example, less than 30 mV) and offset variation. The advantage of the at least four side-protrusion elements 312 is to adjust stress concentration region so as to increase sensitivity of the stress sensing element 199.

In examples of the present disclosure, the stress sensing element 199 further comprises a device connection layer 4. The device connection layer 4 comprises a bottom surface and a top surface opposite the bottom surface. The bottom surface of the device connection layer 4 is directly attached to the structured silicon layer 3. The top surface of the device connection layer 4 is directly attached to the top silicon layer 2.

The top silicon layer 2 further comprises a plurality of reinforcing edge ribs 215 formed by creating a recess 216 above the diaphragm 289 of the suspended region 213. The plurality of reinforcing edge ribs 215 are symmetric with respect to a center point 191 of the diaphragm 289 of the suspended region 213.

The protrusion element 311 is positioned at a center region of the diaphragm 289. A thickness of the protrusion element 311 of the one or more protrusion elements 31 of the structured silicon layer 3 is less than or equal to 100 microns so as to increase sensor sensitivity and to reduce noise. A thickness is measured in a vertical direction from a top surface of the substrate connection layer 5 to a bottom surface of the device connection layer 4. A horizontal direction is perpendicular to the vertical direction. A total thickness variation (TTV) of the thickness of the protrusion element 311 of the one or more protrusion elements 31 of the structured silicon layer 3 is less than 1 micron.

In examples of the present disclosure, a top surface of the diaphragm 289 of the suspended region 213 of the top silicon layer 2 is of a quadrilateral shape. In another example, a top surface of the diaphragm 289 of the suspended region 213 of the top silicon layer 2 is of a square shape.

A number of the one or more protrusion elements 31 (for example, protrusion element 311, at least four side-protrusion elements 312, and at least four constrained-protrusion elements 313 of FIG. 7) is the same as a number of one or more through holes 62. A centerline of each of the one or more protrusion elements 31 is aligned with a centerline of the one or more through holes 62. A bottom surface area of each of the one or more protrusion elements 31 (for example, protrusion element 311, at least four side-protrusion elements 312, and at least four constrained-protrusion elements 313 of FIG. 7) is smaller than an area of an opening of a respective through hole of the one or more through holes 62.

The top silicon layer 2 comprises a silicon device layer 21 and one or more stress sensing units 22. The silicon device layer 21 comprises a top surface 211 and a bottom surface 212 opposite the top surface 211. The silicon device layer 21 further comprises a recess 216 formed downward from the top surface 211 and being located in a suspended region 213. A plurality of reinforcing edge ribs 215 are symmetrically distributed on the suspended region 213. In examples of the present disclosure, the suspended region 213 is of a quadrilateral shape. In another example, the suspended region 213 is of a square shape.

The one or more stress sensing units 22 are disposed corresponding to the plurality of reinforcing edge ribs 215 so as to measure the stress change of the suspended region 213. Each of the one or more stress sensing units 22 includes a sensing layer 221 made of a piezo-resistive material, an insulating protection layer 222 covering the sensing layer 221, and a metal wiring 223 electrically connected to the sensing layer 221 through the insulating protection layer 222. The metal wiring 223 cooperates to transmit the electrical signal sensed by the sensing layer 221 to the environment.

The structured silicon layer 3 is connected to the bottom surface 212 of the silicon device layer 21. The structured silicon layer 3 comprises one or more protrusion elements 31 and an outer frame 32. The one or more protrusion elements 31 comprises an protrusion element 311 corresponding to the center of the suspended region 213, and at least four side-protrusion elements 312 located outside the protrusion element 311, and being spaced apart by a cavity G1. The outer frame 32 is located corresponding to the supported region 214, and being connected to the bottom surface 212 of the silicon device layer 21 via the device connection layer 4. In one example, the material of the device connection layer 4 is silicon dioxide. The spacing S between the at least four side-protrusion elements 312 and the corresponding boundary of the suspended region 213 is between 5 microns and 200 microns. The sensor sensitivity increases when the spacing S reduces. But, feasibility of fabrication process limits the lower limit of the spacing S to be 5 microns.

In one example, the protrusion element 311 is symmetric with respect to a center point 191. A bottom surface of the protrusion element 311 may be of an X-shape, or a cross shape. In examples of the present disclosure, a distance 279 is between a bottom surface of the one or more protrusion elements 31 and a top surface of the substrate.

In one example, the device connection layer 4 is between the top silicon layer 2 and the structured silicon layer 3. In another example, the top silicon layer 2 is directly bonded to the structured silicon layer 3 by a silicon-silicon fusion process so that the stress sensing element 199 excludes a device connection layer 4.

In examples of the present disclosure, a ratio of a surface area of a bottom surface of the protrusion element 311 over a surface area of a bottom surface of the diaphragm 289 is in a range from 5% to 20%.

The substrate 6 comprises a body 61 and one or more through holes 62 passing through the body 61. The material of the body 61 may be selected from the group consisting of silicon, glass, and ceramics. The material of the substrate connection layer 5 may be selected from the group consisting of silicon nitride, silicon dioxide, and polymers. In one example, the body 61 is made of silicon and the substrate connection layer 5 is made of silicon dioxide.

The body 61 comprises a frame 611 connected to the outer frame 32. The one or more through holes 62 pass through the body 61 and are positioned under the suspended region 213. A diameter of each of the one or more through holes 62 is slightly larger (for example, from 0.1% larger to 5% larger) than a diameter of the corresponding side-protrusion of the at least four side-protrusion elements 312 so as to reduce pressure asserted on the suspended region 213.

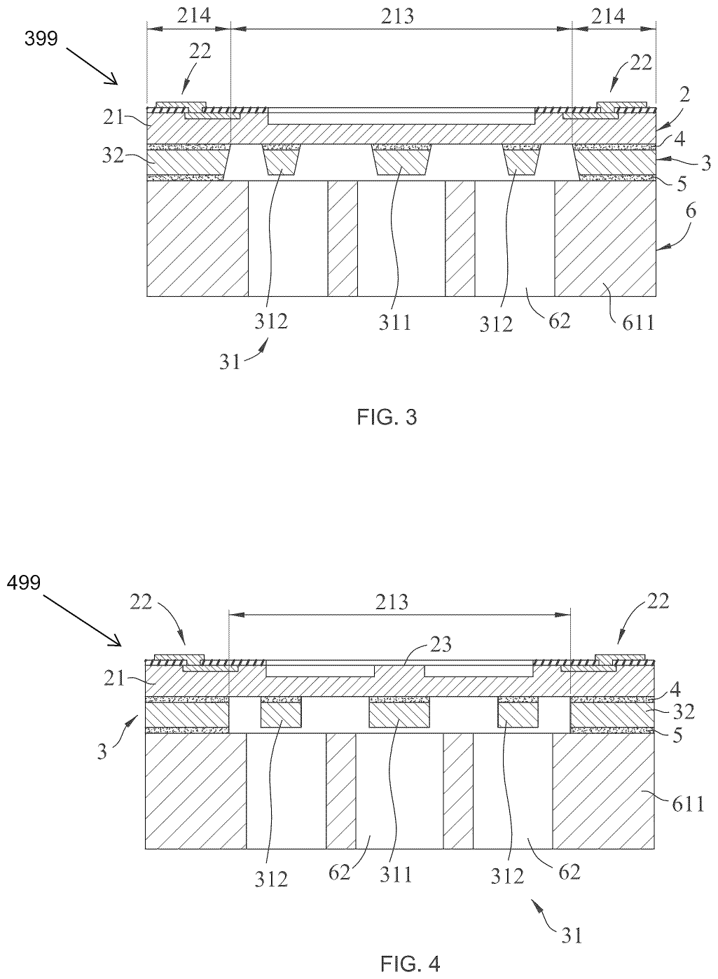

FIG. 3 is a cross-sectional view of a stress sensing element 399 in examples of the present disclosure. The stress sensing element 399 is similar to the stress sensing element 199 of FIGS. 1 and 2 except that side walls of the protrusion element 311 and side walls of the at least four side-protrusion elements are of taper shapes (narrower towards the substrate 6) so as to adjust stress distribution. In one example, because of the taper shapes, a surface area of a top surface of the outer frame 32 of the structured silicon layer 3 is larger than a surface area of a bottom surface of the substrate connection layer 5. In another example, for straight wall construction of FIG. 2, a surface area of a top surface of the outer frame 32 of the structured silicon layer 3 is equal to a surface area of a bottom surface of the substrate connection layer 5.

FIG. 4 is a cross-sectional view of a stress sensing element 499 in examples of the present disclosure. The stress sensing element 499 is similar to the stress sensing element 199 of FIGS. 1 and 2 except that a boss 23 extends upward from the diaphragm 289.

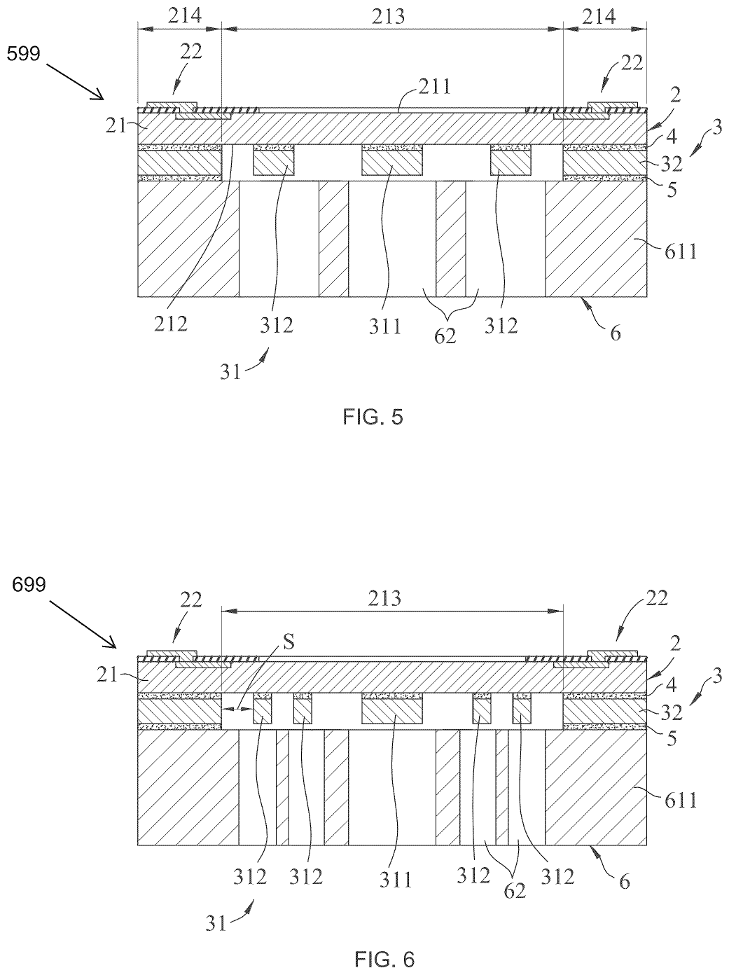

FIG. 5 is a cross-sectional view of a stress sensing element 599 in examples of the present disclosure. The stress sensing element 599 is similar to the stress sensing element 199 of FIGS. 1 and 2 except that the stress sensing element 599 of FIG. 5 extrudes the recess 216 of FIG. 2 so as to simplify the fabrication process.

FIG. 6 is a cross-sectional view of a stress sensing element 699 in examples of the present disclosure. The stress sensing element 699 is similar to the stress sensing element 599 of FIG. 5 except that a number of at least four side-protrusion elements 312 is increased. Each of an inner loop of the at least four side-protrusion elements 312 is between a respective one of an outer loop of the at least four side-protrusion elements 312 and the protrusion element 311.

FIG. 7 is a cross-sectional view of a stress sensing element 799 in examples of the present disclosure. The stress sensing element 799 is similar to the stress sensing element 199 of FIGS. 1 and 2 except that the stress sensing element 799 further comprises at least four constrained-protrusion elements 313. In examples of the present disclosure, the one or more protrusion elements 31 further comprises at least four constrained-protrusion elements 313. The at least four constrained-protrusion elements 313 are symmetric with respect to the center point 191 of FIG. 1 of the protrusion element 311. A centerline of each of the at least four constrained-protrusion elements 313 is not aligned with a centerline of any of the one or more through holes 62. Each of the at least four constrained-protrusion elements 313 is completely offset against the one or more through holes 62. A gap G2 between a bottom surface of the at least four constrained-protrusion elements 313 and a top surface of the substrate 6 is less than or equal to 5 microns. The at least four constrained-protrusion elements 313 can limit the vertical motion of the diaphragm 289.

The one or more protrusion elements 31 further comprises at least four side-protrusion elements 312. The at least four side-protrusion elements 312 are symmetric with respect to the center point 191 of the protrusion element 311. A thickness of the at least four side-protrusion elements 312 is less than or equal to 100 microns so as to increase sensor sensitivity and to reduce noise. A total thickness variation of the thickness of the at least four side-protrusion elements 312 is less than 1 micron. A shortest distance between a side surface of the at least four side-protrusion elements 312 and an edge of the diaphragm 289 of the supported region 214 is in a range from 5 microns to 200 microns.

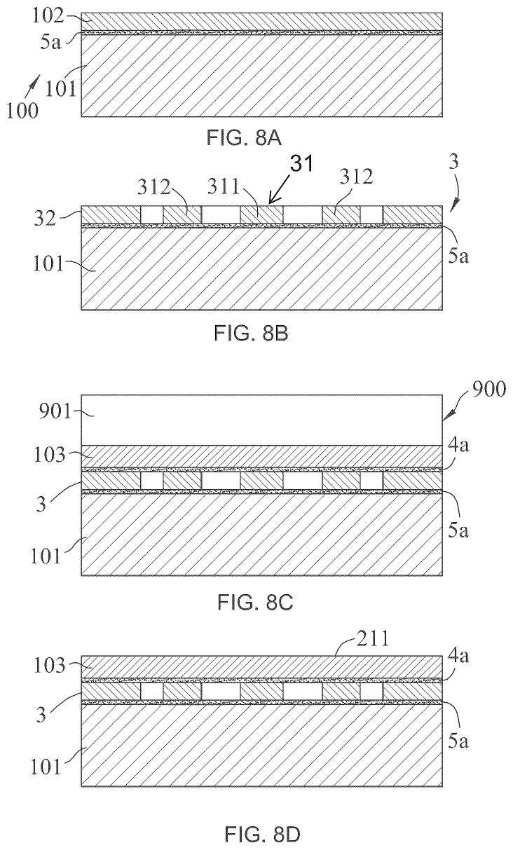

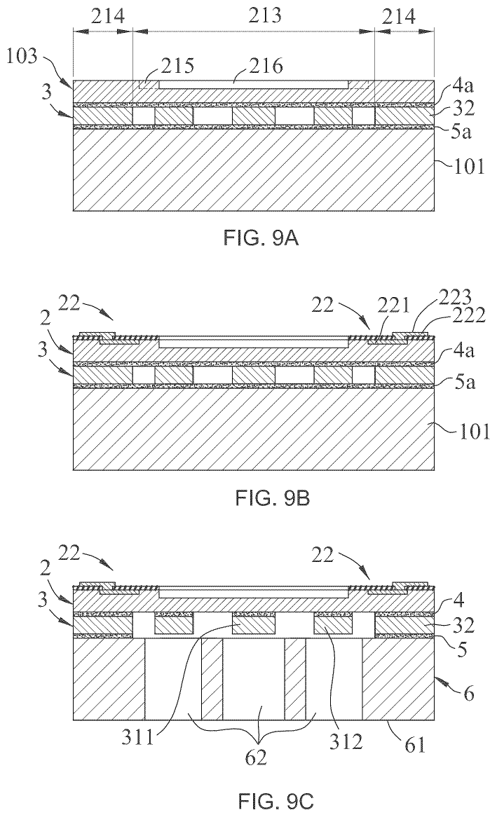

Referring now to FIGS. 2, 8A, 8B, 8C, 8D, 9A, 9B, and 9C. FIGS. 8A, 8B, 8C, and 8D show cross-sectional views of a first portion of a process to fabricate stress sensing elements of FIGS. 1-6 in examples of the present disclosure. FIGS. 9A, 9B, and 9C show cross-sectional views of a second portion of a process to fabricate stress sensing elements of FIGS. 1-6 in examples of the present disclosure.

FIGS. 8A, 8B, 8C, 8D, 9A, 9B, and 9C show the manufacturing steps for fabricating a single stress sensing element. In FIG. 8A, a wafer 100 is provided. In one example, the wafer 100 is a silicon on insulator (SOI) wafer. The wafer 100 comprises a first layer 101, a second layer 102, and an etching stop layer 5a. The second layer 102 is used to define the one or more protrusion elements 31. In one example, a thickness of the second layer 102 is the same as a thickness of the one or more protrusion elements 31. After all the manufacturing steps, the etching stop layer 5a becomes the substrate connection layer 5.

In FIG. 8B, an etching process is applied to the second layer 102. The etched depth stops at a top surface of the etching stop layer 5a. A structured silicon layer 3 is formed. The structured silicon layer 3 comprises an outer frame 32 and one or more protrusion elements. In one example, the one or more protrusion elements 31 comprise a protrusion element 311. In another example, the one or more protrusion elements 31 comprise a protrusion element 311 and at least four side-protrusion elements 312. In still another example, the one or more protrusion elements 31 comprise a protrusion element 311, at least four side-protrusion elements 312, and at least four constrained-protrusion elements 313 of FIG. 7.

In FIG. 8C, an device substrate 900 is attached to the structured silicon layer 3. In one example, the attachment is by a Si—SiO2 fusion bonding process. In examples of the present disclosure, the device substrate 900 is a silicon wafer or an SOI wafer. The device substrate 900 comprises an etching stop layer 4a, a device portion 103, and a handle portion 901. After all the manufacturing steps, the etching stop layer 4a becomes the device connection layer 4.

In FIG. 8D, the handle portion 901 is removed so that a top surface 211 of the device portion 103 is exposed.

In FIG. 9A, a portion of material of the device portion 103 is removed, by dry etching, wet etching, or laser, so as to form the recess 216. A suspended region 213, a supported region 214, and a plurality of reinforcing edge ribs 215 are defined.

Alternatively, the device portion 103 and the structured silicon layer 3 may be directly bonded by a Si—Si fusion bonding process without the presence of the etching stop layer 5a.

In FIG. 9B, one or more stress sensing units 22 are formed by an ion-implantation process. The one or more stress sensing units 22 comprise a sensing layer 221 made of a piezo-resistive material, an insulating protection layer 222 covering the sensing layer 221, and a metal wiring 223 electrically connected to the sensing layer 221 through the insulating protection layer 222. The metal wiring 223 cooperates to transmit the electrical signal sensed by the sensing layer 221 to the environment.

In FIG. 9C, one or more through holes 62 are formed through the substrate 6 by dry etching, wet etching, laser, CNC, or sandblasting. Portions of the etching stop layer 5a are removed by dry etching or wet etching so as to form the substrate connection layer 5.

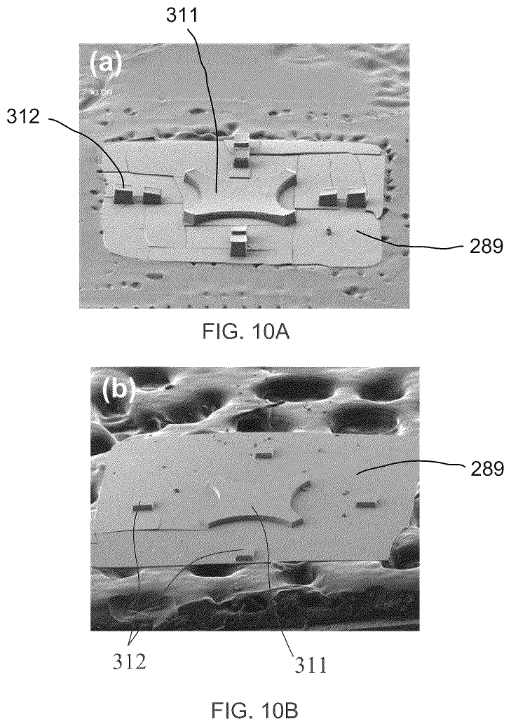

FIG. 10A shows a SEM picture of a portion of a suspended region 213 of a stress sensing element and FIG. 10B shows a SEM picture of a portion of a suspended region 213 of another stress sensing element in examples of the present disclosure. FIGS. 10A and 10B are presented in an upside down configuration that the diaphragm 289 is below the protrusion element 311. The surface smoothness of the protrusion 311 and the diaphragm 289 of FIG. 10B is better than that of the diaphragm 289 of FIG. 10A. Without using the etching stop layer 5a to form the stress sensing element of FIG. 10A, the TTV of the protrusion element 311 of FIG. 10A is larger than the TTV of the protrusion element 311 of FIG. 10B that uses the etching stop layer 5a.

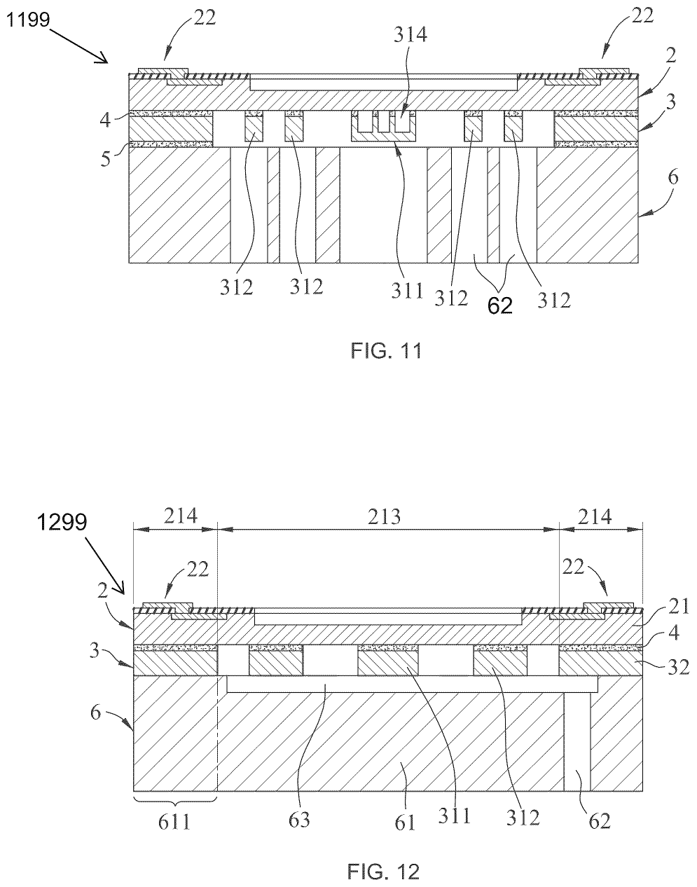

FIG. 11 is a cross-sectional view of a stress sensing element 1199 in examples of the present disclosure. The stress sensing element 1199 is similar to the stress sensing element 199 of FIGS. 1 and 2 except that the protrusion element 311 comprises a plurality of holes or a plurality of internal cavities 314 so as to reduce the weight of the protrusion element 311 thereby reducing the noise of the stress sensing element. Though 3 holes are shown in FIG. 11, a number of the plurality of holes 314 may vary. The number of the plurality of holes 314 may be made by an aspect-ratio dependent etching method.

FIG. 12 is a cross-sectional view of a stress sensing element 1299 in examples of the present disclosure. The stress sensing element 1299 is similar to the stress sensing element 199 of FIGS. 1 and 2 except that a recess 63 is formed on a top portion of the substrate 6 and at least one of the one or more through holes 62 is connected to the recess 63. The substrate 6 further comprises a recess 63 below the one or more protrusion elements. An opening of the recess 63 accommodates a respective bottom surface of each protrusion element of the one or more protrusion elements. The recess 63 connects to at least one of the one or more through holes 62. A distance from a centerline of the at least one of the one or more through holes 62 to a centerline of the stress sensing element is larger than a distance from an inner sidewall of the outer frame 32 to the centerline of the stress sensing element.

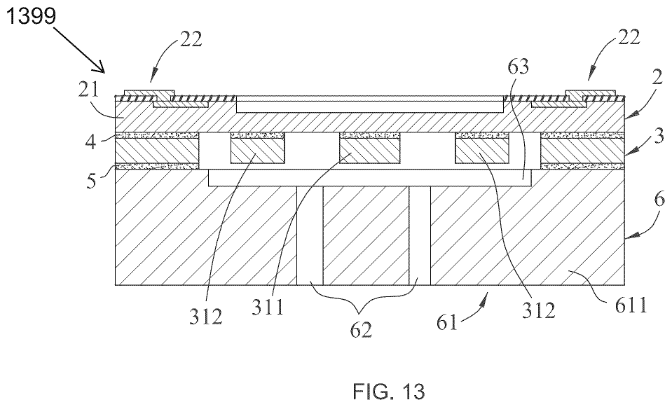

FIG. 13 is a cross-sectional view of a stress sensing element 1399 in examples of the present disclosure. The stress sensing element 1399 is similar to the stress sensing element 199 of FIGS. 1 and 2 except that a recess 63 is formed on a top portion of the substrate 6 and the one or more through holes 62 are connected to the recess 63.

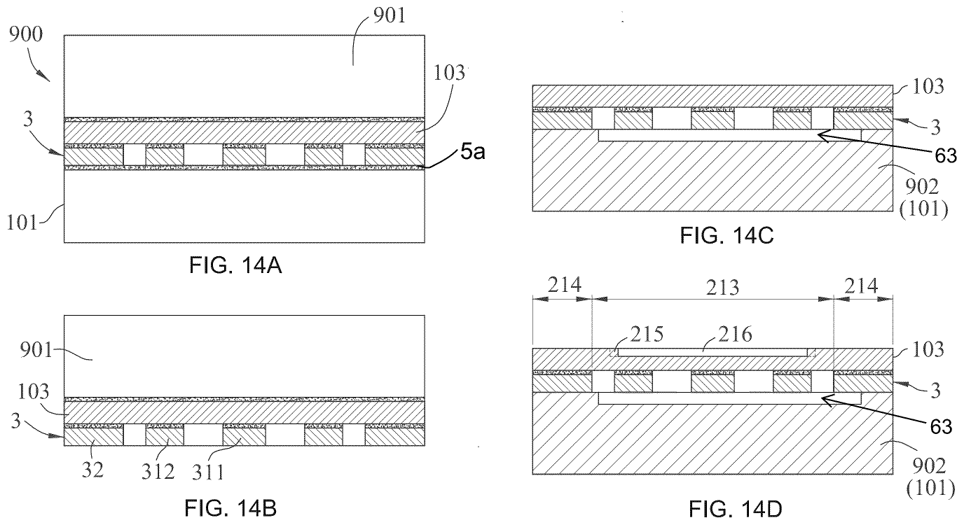

FIGS. 14A, 14B, 14C, and 14D show cross-sectional views of a portion of a process to fabricate stress sensing elements of FIGS. 12 and 13 in examples of the present disclosure.

The structure of FIG. 14A is similar to the structure of FIG. 8C. In FIG. 14A, the first layer 101 may be a handle layer of an SOI. The structured silicon layer 3 may be a device layer of the SOI.

In FIG. 14B, the first layer 101 and the etching stop layer 5a are removed so that the outer frame 32, the protrusion element 311, and the at least four side-protrusion elements are exposed.

In FIG. 14C, a substrate 902 comprising a recess 63 is attached to the outer frame 32 by a Si—Si fusion bonding method or a Si—SiO₂ fusion bonding method. The handle portion 901 in FIG. 14B is then removed so that a top surface of the device portion 103 is exposed.

In FIG. 14D, a portion of material of the device portion 103 is removed, by dry etching, wet etching, or laser, so as to form the recess 216. A suspended region 213, a supported region 214, and a plurality of reinforcing edge ribs 215 are defined.

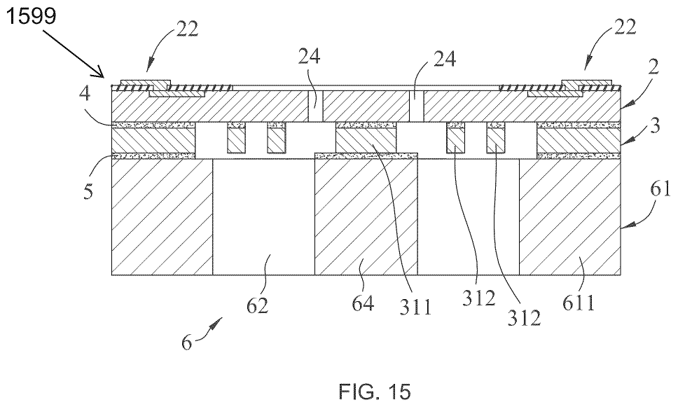

FIG. 15 is a cross-sectional view of a stress sensing element 1599 in examples of the present disclosure. The stress sensing element 1599 is similar to the stress sensing element 199 of FIGS. 1 and 2 except that the substrate 6 further comprises a ring shape through hole surrounding a column 64. The one or more through holes 62 of the substrate 6 comprise a ring shape through hole. The substrate 6 further comprises a column 64 directly surrounded by the ring shape through hole. A top surface of the column 64 of the substrate 6 is attached to a bottom surface of the protrusion element 311 of the one or more protrusion elements 31 of the structured silicon layer 3 by a portion of the substrate connection layer 5.

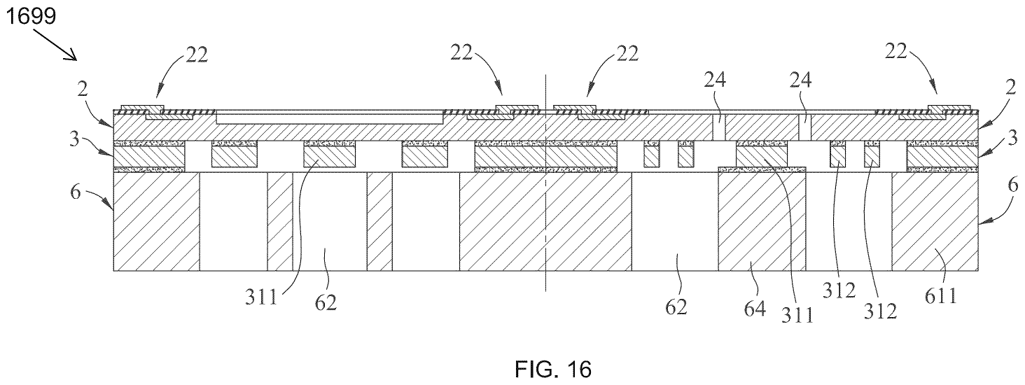

FIG. 16 is a cross-sectional view of a combo stress sensing element 1699 in examples of the present disclosure. The combo stress sensing element 1699 combines the stress sensing element 199 of FIGS. 1 and 2 and the stress sensing element 1599 of FIG. 15.

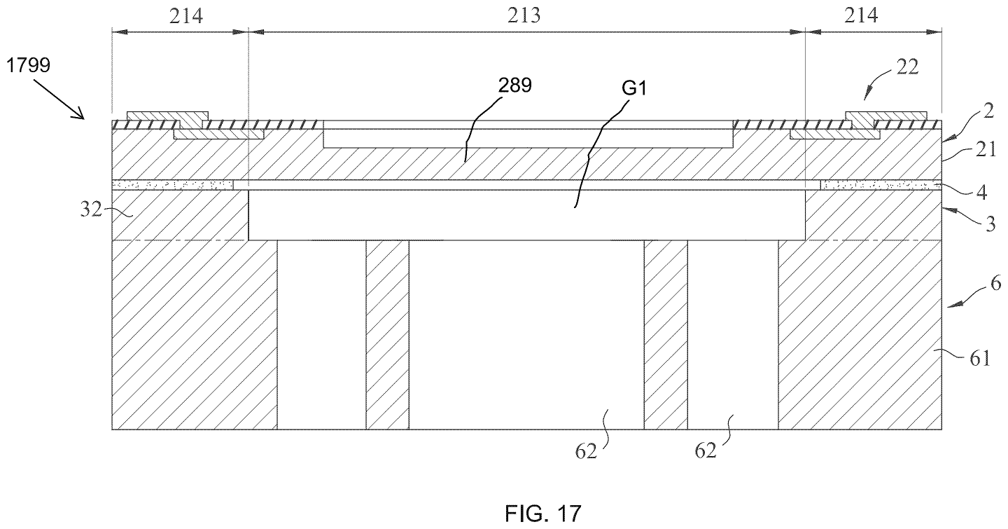

FIG. 17 is a cross-sectional view of a stress sensing element 1799 in examples of the present disclosure. The stress sensing element 1799 is similar to the stress sensing element 199 of FIGS. 1 and 2 except that the one or more protrusion elements 31 and the substrate connection layer 5 were absent.

The stress sensing element 1799 comprises a substrate 6, a structured silicon layer 3, device connection layer 4, and a top silicon layer 2. The substrate 6 comprises one or more through holes 62. The structured silicon layer 3 comprises an outer frame 32 and a cavity G1. The outer frame 32 is attached to a body 61 of the substrate 6. The cavity G1 is connected to the one or more through holes 62 of the substrate 6.

The device connection layer 4 comprises a bottom surface and a top surface opposite the bottom surface. The bottom surface of the device connection layer 4 is directly attached to the structured silicon layer 3. The top surface of the device connection layer 4 is directly attached to the top silicon layer 2.

The top silicon layer 2 comprises a supported region 214, a suspended region 213, and one or more stress sensing units 22. The supported region 214 is supported by the outer frame 32 of the structured silicon layer 3. The suspended region 213 comprises a diaphragm 289. The one or more stress sensing units 22 sense stresses while under applied pressure in the suspended region 213.

In examples of the present disclosure, a width of the device connection layer 4 is shorter than a width of the outer frame 32 of the structured silicon layer 3 by at least 2 microns. Each side edge of the device connection layer 4 is aligned with a respective side edge of the structured silicon layer 3.

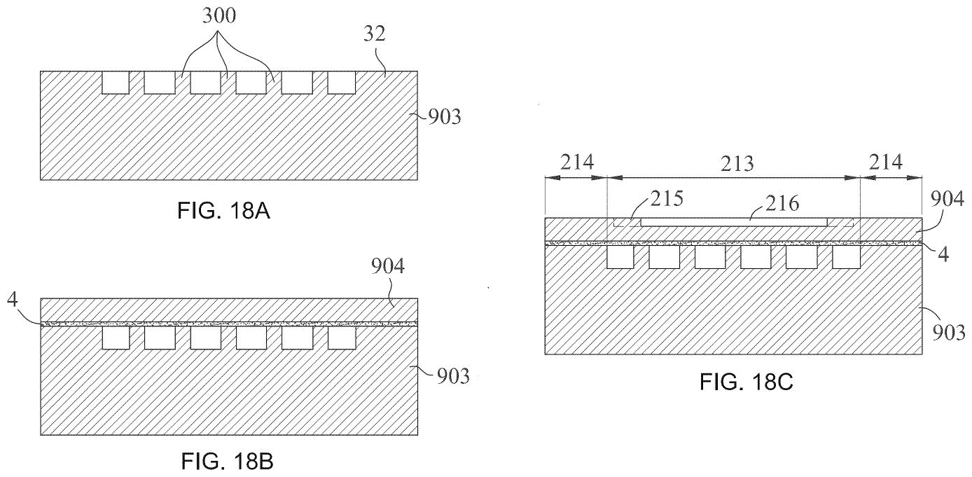

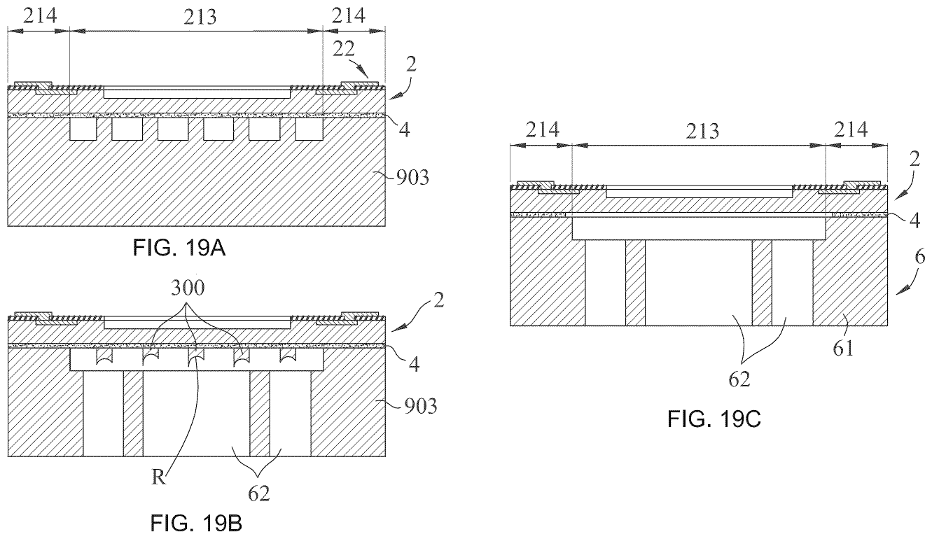

FIGS. 18A, 18B, and 18C show cross-sectional views of a first portion of a process to fabricate stress sensing elements of FIG. 17 in examples of the present disclosure. FIGS. 19A, 19B, and 19C show cross-sectional views of a second portion of a process to fabricate stress sensing elements of FIG. 17 in examples of the present disclosure.

In FIG. 18A, a substrate 903 is provided. The substrate 903 comprises an outer frame 32 and a plurality of protrusions 300. The plurality of protrusions 300 may be formed by an etching process.

In FIG. 18B, a substrate 904 is attached to the substrate 903 by a device connection layer 4. A thickness of the substrate 904 is smaller than a thickness of the substrate 903.

In FIG. 18C, a portion of material of the substrate 904 is removed, by dry etching, wet etching, or laser, so as to form the recess 216. A suspended region 213, a supported region 214, and a plurality of reinforcing edge ribs 215 are defined.

In FIG. 19A, one or more stress sensing units 22 are formed.

In FIG. 19B, one or more through holes 62 passing through the substrate 903 are formed by an etching process. Portions of the plurality of protrusions 300 are removed resulting in uneven surfaces R.

In FIG. 19C, the remaining portions of the plurality of protrusions 300 are removed by etching.

The advantages of the process described in FIGS. 18A, 18B, 18C, 19A, 19B, and 19C include simpler manufacturing process and lower cost.

Alternatively, different from FIG. 17, it can also retain the protrusion element 311 by designing the protrusion element 311 with a properly larger width. The structured silicon layer 3 of the stress sensing element 1799 further comprises the protrusion element 311 of the one or more protrusion elements 31 of the structured silicon layer 3 is attached to a central portion of the diaphragm 289 of the suspended region 213 of the top silicon layer 2 by the device connection layer 4. A total thickness variation of a thickness of the protrusion element 311 is less than 1 micron.

The advantage of the stress sensing elements of FIGS. 1-16 include: the one or more protrusion elements 31 of the structured silicon layer 3 provide support to the top silicon layer 2 and prevent the top silicon layer 2 from being deformed during manufacturing process. Since the stress sensing element can be manufactured by using two SOI wafer processes, the thickness and bottom surface flatness of the one or more protrusion elements 31 can be effectively controlled. Therefore, in one example, the protrusion element thickness variation of the one or more protrusion elements 31 is less than 5 microns. In examples of the present disclosure, the thickness of the one or more protrusion elements 31 is less than or equal to 100 microns for reduced output noise from vibration. The total thickness variation of each protrusion element (the protrusion element 311, the at least four side-protrusion elements 312) itself is less than 1 micron. It can improve the overall performance including linearity, yield, and vibration noise reduction. In addition, the stress distribution can be adjusted through the design of the shape, structure and quantity of the one or more protrusion elements 31 to obtain a more stable stress sensing element with better sensing sensitivity.

The advantage of the stress sensing elements of FIGS. 17-19C include: bases on the design of the device connection layer 4, the one or more protrusion elements 31 with an uneven bottom surface can be selectively peeled off and removed during the manufacturing process. The one or more protrusion elements 31 do not need to be manufactured using a more expensive SOI wafer, but can be manufactured using a lower-cost process. It can also retain the protrusion element 311 by design to reduce the performance variation of the stress sensing element.

Those of ordinary skill in the art may recognize that modifications of the embodiments disclosed herein are possible. For example, a number of one or more protrusion elements 31 may vary. Other modifications may occur to those of ordinary skill in this art, and all such modifications are deemed to fall within the purview of the present invention, as defined by the claims.

1. A stress sensing element comprising:
a substrate comprising:
one or more through holes;
a substrate connection layer attached to the substrate;
a structured silicon layer comprising:
one or more protrusion elements comprising:
a protrusion element,
an outer frame attached to the substrate connection layer, and
a cavity connected to the one or more through holes of the substrate, and
a top silicon layer comprising:
a supported region supported by the outer frame of the structured silicon layer,
a suspended region comprising:
a diaphragm; and
one or more stress sensing units sensing stresses in the suspended region;
wherein the protrusion element of the one or more protrusion elements of the structured silicon layer is attached to the diaphragm of the suspended region of the top silicon layer.

2. The stress sensing element of claim 1 further comprising a device connection layer comprising:
a bottom surface directly attached to the structured silicon layer; and
a top surface opposite the bottom surface, the top surface of the device connection layer being directly attached to the top silicon layer.

3. The stress sensing element of claim 1, wherein a surface area of a top surface of the outer frame of the structured silicon layer is larger than or equal to a surface area of a bottom surface of the substrate connection layer.

4. The stress sensing element of claim 1, wherein the top silicon layer further comprises:
a plurality of reinforcing edge ribs formed by creating a recess above the diaphragm of the suspended region;
wherein the plurality of reinforcing edge ribs are symmetric with respect to a center point of the diaphragm of the suspended region.

5. The stress sensing element of claim 1, wherein the protrusion element is positioned at a center region of the diaphragm;
wherein a thickness of the protrusion element of the one or more protrusion elements of the structured silicon layer is less than or equal to one hundred microns; and
wherein a total thickness variation of the thickness of the protrusion element of the one or more protrusion elements of the structured silicon layer is less than one micron.

6. The stress sensing element of claim 5, wherein the one or more through holes of the substrate comprise:
a through hole;
wherein the substrate further comprises:
a column comprising:
one or more side surfaces directly surrounded by the through hole; and
wherein a top surface of the column of the substrate is attached to a bottom surface of the protrusion element of the one or more protrusion elements of the structured silicon layer.

7. The stress sensing element of claim 1, wherein a top surface of the diaphragm of the suspended region of the top silicon layer is of a quadrilateral shape;
wherein the one or more protrusion elements further comprises:
at least four side-protrusion elements;
wherein the at least four side-protrusion elements are symmetric with respect to a center point of the protrusion element;
wherein a thickness of the at least four side-protrusion elements is less than or equal to one hundred microns;
wherein a total thickness variation of the thickness of the at least four side-protrusion elements is less than one micron; and
wherein a shortest distance between a side surface of the at least four side-protrusion elements and an edge of the diaphragm of the suspended region is in a range from five microns to two hundred microns.

8. The stress sensing element of claim 1, wherein the one or more protrusion elements further comprises:
at least four constrained-protrusion elements;
wherein the at least four constrained-protrusion elements are symmetric with respect to a center point of the protrusion element; and
wherein a shortest distance between a bottom surface of the at least four constrained-protrusion elements and a top surface of the substrate is less than or equal to five microns.

9. The stress sensing element of claim 1, wherein the protrusion element comprises a plurality of holes or a plurality of internal cavities.

10. The stress sensing element of claim 1, wherein a number of the one or more protrusion elements is the same as a number of one or more through holes; and
wherein a bottom surface area of each of the one or more protrusion elements is smaller than an area of an opening of a respective through hole of the one or more through holes.

11. The stress sensing element of claim 1, wherein the substrate further comprises:
a recess below the one or more protrusion elements;
wherein an opening of the recess accommodates a respective bottom surface of each protrusion element of the one or more protrusion elements; and
wherein the recess connects to at least one of the one or more through holes.

12. The stress sensing element of claim 11, wherein a distance from a centerline of the at least one of the one or more through holes to a centerline of the stress sensing element is larger than a distance from an inner sidewall of the outer frame to the centerline of the stress sensing element.

13. A stress sensing element
a substrate comprising:
one or more through holes;
a structured silicon layer attached to the substrate, the structured silicon layer comprising:
an outer frame attached to the substrate, and
a cavity connected to the one or more through holes of the substrate;
a device connection layer comprising:
a bottom surface directly attached to the structured silicon layer; and
a top surface opposite the bottom surface;
a top silicon layer comprising:
a supported region directly attached to the top surface of the device connection layer, the supported region being supported by the outer frame of the structured silicon layer,
a suspended region comprising:
a diaphragm; and
one or more stress sensing units sensing stresses in the suspended region.

14. The stress sensing element of claim 13, wherein a width of the device connection layer is shorter than a width of the outer frame of the structured silicon layer; and
wherein each side edge of the device connection layer is aligned with a respective side edge of the structured silicon layer.

15. The stress sensing element of claim 14, wherein the structured silicon layer further comprises:
one or more protrusion elements comprising:
a protrusion element;
wherein the protrusion element of the one or more protrusion elements of the structured silicon layer is attached to a central portion of the diaphragm of the suspended region of the top silicon layer by the device connection layer; and
wherein a total thickness variation of a thickness of the protrusion element is less than one micron.
